(19) United States
(12) Patent Application Publication
(10) Pub. No.: US 2021/0390378 A1
(43) Pub. Date: Dec. 16, 2021

(54) ARITHMETIC PROCESSING DEVICE, INFORMATION PROCESSING APPARATUS, AND ARITHMETIC PROCESSING METHOD

(71) Applicant: KABUSHIKI KAISHA TOSHIBA, Tokyo (JP)

(72) Inventor: Mizuki ONO, Yokohama Kanagawa (JP)

(73) Assignee: KABUSHIKI KAISHA TOSHIBA, Tokyo (JP)

(21) Appl. No.: 17/180,720

(22) Filed: Feb. 19, 2021

(30) Foreign Application Priority Data
Jun. 11, 2020 (JP) 2020-101414

(51) Int. Cl. G06N 3/04; G06N 3/08

(52) U.S. Cl. CPC G06N 3/0472; G06N 3/08

(57) ABSTRACT

According to an embodiment, an arithmetic processing device includes a reception unit, and a calculation unit. The reception unit is configured to receive a plurality of pairs each consisting of a first floating-point value output as an output result of first processing and a second floating-point value output as an output result of second processing. The calculation unit is configured to perform linear regression on the plurality of pairs and calculate a degree of similarity between output results of the first processing and output results of the second processing, based on information obtained by the linear regression.

### CROSS-REFERENCE TO RELATED APPLICATIONS

This application is based upon and claims the benefit of priority from Japanese Patent Application No. 2020-101414, filed on Jun. 11, 2020; the entire contents of which are incorporated herein by reference.

### FIELD

Embodiments described herein relate generally to an arithmetic processing device, an information processing apparatus, and an arithmetic processing method.

### BACKGROUND

For example, when desired processing such as processing of a neural network or artificial intelligence is executed by a plurality of methods using a field programmable gate array (FPGA), it is necessary to verify that processing equivalent to desired processing is performed. When floating-point values are used as values, rounding errors occur in association with the values. Processing results obtained by methods that employ different manners for handling floating-point values are different in a strict sense even when equivalent processing is performed.

### BRIEF DESCRIPTION OF THE DRAWINGS

FIG. 1 is a diagram illustrating an example of a graph in which two values expressed as floating-point values are plotted along the abscissa and along the ordinate;

FIG. 2 is a diagram illustrating an example of the functional configuration of an arithmetic processing device according to a first embodiment;

FIG. 3 is a flowchart illustrating an example of an arithmetic processing method according to the first embodiment;

FIG. 4 is a diagram illustrating an example of the functional configuration of an information processing apparatus according to a second embodiment;

FIG. 5 is a flowchart illustrating an example of an arithmetic processing method according to the second embodiment;

FIG. 6 is a diagram illustrating an example of the functional configuration of an information processing system according to a third embodiment; and

FIG. 7 is a diagram illustrating an example of the hardware configuration of an information processing apparatus according to each of the second and the third embodiments.

### DETAILED DESCRIPTION

According to an embodiment, an arithmetic processing device includes a reception unit, and a calculation unit. The reception unit is configured to receive a plurality of pairs each consisting of a first floating-point value output as an output result of first processing and a second floating-point value output as an output result of second processing. The calculation unit is configured to perform linear regression on the plurality of pairs and calculate a degree of similarity between output results of the first processing and output results of the second processing, based on information obtained by the linear regression.

The following describes embodiments of an arithmetic processing device, an information processing system, and an arithmetic processing method in detail with reference to the attached drawings.

### First Embodiment

For example, when desired processing such as processing of a neural network or artificial intelligence is executed using different arithmetic processing devices, the desired processing is performed based on definitions thereof, for example, in a central processing unit (CPU) or a graphics processing unit (GPU). However, for example, when desired processing is performed in parallel using a field programmable gate array (FPGA), there is a possibility that the desired processing is not performed based on definitions thereof but is performed in a processing sequence that is changed from a defined sequence. For this reason, when desired processing is executed using different arithmetic processing devices, it is necessary to check processing results outputted as floating-point values.

When values expressed as floating-point values are compared (checked), it is necessary to confirm whether the both are similar to each other. A possible method for quantifying the degree of similarity therebetween and quantitatively comparing these values is, for example, to check the absolute value of the difference between values corresponding to each other (values being compared). However, a true value (original value) is necessary to allow the absolute value to be interpreted as the degree of similarity. The true value is, for example, a value obtained by causing, for example, a CPU or a GPU to perform the desired processing as defined. For example, the true value is a value of training data that is used for machine learning.

For example, if the absolute value of two values obtained by different methods is 10⁻⁵ and the true value is 10⁻², when the proportion (ratio) therebetween is taken as the relative difference therebetween, the relative difference therebetween is calculated as 10⁻⁵/10⁻²=10⁻³. If the value of the true value is 10⁻⁶, the relative difference therebetween is calculated to be 10⁻⁵/10⁻⁶=10⁺¹. This example explains that only having the absolute value of the difference between two values obtained by different methods is insufficient for determination in which the degrees of similarity of these values with the true value are taken into consideration.

As another alternative method, it is also considered possible to check the ratio of the absolute value of the difference between corresponding values to the true value. However, when the true value is 0, the ratio cannot be defined, and it is therefore impossible to quantitatively determine the degree of similarity using this method.

As another possible method is to confirm whether a graph in which one and the other of each of pairs of values to be compared with each other are plotted along the abscissa and along the ordinate, respectively, is close to a straight line passing through the origin and having a slope of one. However, it is impossible to quantitatively determine the degree of similarity only by confirming whether “the graph is close to the straight line”.

As described above, it is difficult to quantitatively determine the degrees of similarity between values expressed as floating-point values. Therefore, when desired processing is performed, for example, on an FPGA by a plurality of methods, it has been difficult to compare the degrees of similarity between values expressed as floating-point values with each other and select a method by which values that are the closest to true values can be obtained.

The following describes an arithmetic processing device, an arithmetic processing method, and a computer program that enable quantitatively determine the degrees of similarity between values expressed as floating-point values and consequently enable quantitative comparison among the degrees of similarity.

Although some of the values in the following description are given as specific values for the sake of explanation, such specific values themselves are not essential and may be other values. Embodiments according to the present disclosure are not limited to the embodiments described below, and the embodiments described below can be used in various modifications.

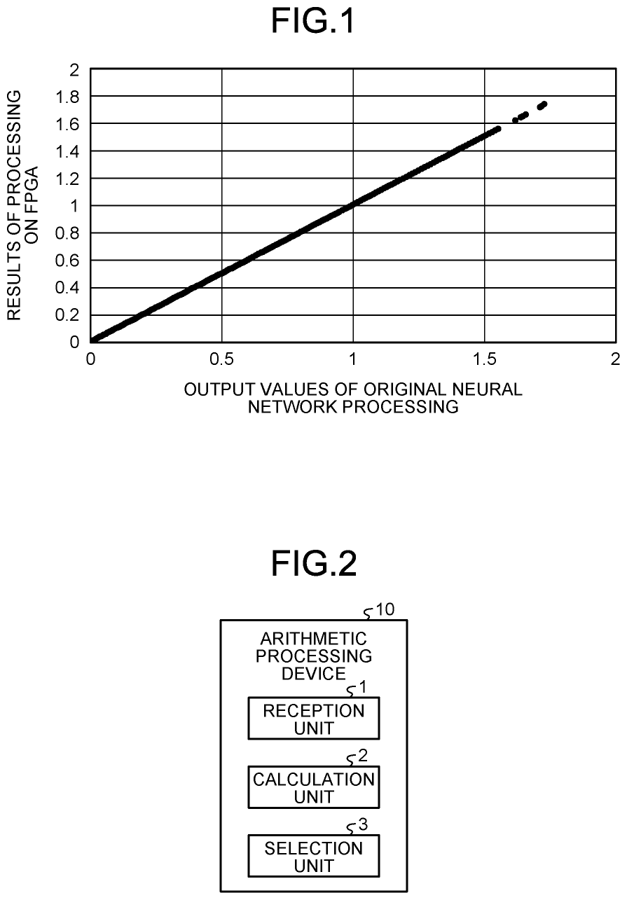

For example, FIG. 1 illustrates, regarding the result of max pooling processing subsequent to a first convolution processing in a 50-layer residual network, as disclosed in K. He, X. Zhang, S. Ren, and J. Sun, “Deep Residual Learning for Image Recognition”, a graph obtained by plotting, along the abscissa, results obtained by performing arithmetic processing using a GPU based on original definitions of the convolution processing and the max pooling processing and, along the ordinate, results obtained by performing parallel processing using an FPGA.

It is found that the graph in FIG. 1 is extremely close to a straight line passing through the origin and having a slope of 1. That is, the pairs each consisting of two values are similar to each other. However, the degree of similarity therebetween cannot be quantitatively determined based on the graph in FIG. 1.

Next, the functional configuration of an arithmetic processing device according to a first embodiment that enables quantitative determination of degrees of similarity is described.

Example of Functional Configuration FIG. 2 is a diagram illustrating an example of the functional configuration of an arithmetic processing device 10 according to a first embodiment. The arithmetic processing device 10 according to the first embodiment includes a reception unit 1, a calculation unit 2, and a selection unit 3.

The reception unit 1 receives a plurality of pairs each consisting of a first floating-point value output as an output result of first processing and a second floating-point value output as an output result of second processing. For example, the output result of the first processing is an output result of parallel processing performed using an FPGA (the ordinate in FIG. 1). For example, the output result of the second processing is an output result of arithmetic processing performed using an GPU (the abscissa in FIG. 1).

The calculation unit 2 performs linear regression on the pairs and, based on information obtained by the linear regression, calculates the degree of similarity between the output results of the first processing and the output results of the second processing. Linear regression is a method for determining a slope and an intercept (ordinate intercept) of an assumed linear function that minimizes the sum of squares of the differences between the assumed linear function and true values. For example, the calculation unit 2 calculates the degree of similarity based on at least one of the slope of a regression line obtained by the linear regression, the intercept of the regression line, and the correlation coefficient obtained by the linear regression. When the first processing is executed by a plurality of methods, the calculation unit 2 calculates the degree of similarity between output results of the first processing executed by each of the methods and the output results of the second processing.

The selection unit 3 selects, based on the degrees of similarity that have been calculated by the calculation unit 2, a method from the methods by which the first processing has been performed.

In the above-described example of FIG. 1, with a plurality of pairs each consisting of a value plotted along the abscissa and a corresponding value plotted along the ordinate, when the calculation unit 2 performs linear regression on the pairs, the following information is obtained by the linear regression, for example.

The slope of the regression line=1+1.64×10⁻⁸; the intercept of the regression line=−2.64×10⁻⁹; and the correlation coefficient=1−8.62×10⁻¹³.

If, hypothetically, two values included in each of the pairs are equal to each other in a strict sense, the graph is a straight line passing through an origin and having a slope of 1. Therefore, the slope and the intercept of a regression line and the correlation coefficient obtained as result of the linear regression are 1, 0, and 1, respectively. Thus, as to the slope, the degree of similarity between two values included in each of the pairs is higher as the difference between the slope of the regression line obtained by the linear regression and 1 is smaller. As to the intercept, the degree of similarity between two values included in each of the pairs is higher as the value of the intercept obtained by the linear regression is closer to 0. Furthermore, as to the correlation coefficient, the degree of similarity between two values included in each of the pairs is higher as the difference between the correlation coefficient obtained by the linear regression and 1 is smaller.

Therefore, the degree of similarity between such two values can be quantitatively determined using the difference between the slope obtained by actually performing linear regression and 1, the value of the intercept obtained thereby, or the difference between the correlation coefficient obtained thereby and 1. In doing so, the degree of similarity of a plurality of pairs each consisting of two values expressed as floating-point values can be quantitatively determined. Therefore, for example, when processing of a specific neural network or artificial intelligence is performed on an FPGA by a plurality of methods, quantitative comparison among these methods is made possible, for example, in the following manner. Furthermore, enabling quantitative comparison among these methods enables selection of a more appropriate method, whereby arithmetic processing that delivers higher performance can be implemented.

A plurality of methods are denoted as, for example, Method A, Method B, and so on. The following description takes, as an example, a case in which Methods A and B are compared with each other. The same is applied to comparison between two methods and to comparison among three or more methods.

The calculation unit 2 performs linear regression between results of arithmetic processing performed on an FPGA by Method A and results of arithmetic processing performed using, for example, a CPU or a GPU based on definitions of desired processing. The slope, the intercept, and the correlation coefficient obtained by this linear regression are denoted as Slope A, Intercept A, and Correlation Coefficient A, respectively.

In the same manner, the calculation unit 2 performs linear regression between results of arithmetic processing performed on an FPGA by Method B and results of arithmetic processing performed using, for example, a CPU or a GPU based on definitions of the desired processing. The slope, the intercept, and the correlation coefficient obtained by this linear regression are denoted as Slope B, Intercept B, and Correlation Coefficient B, respectively.

For example, using the absolute value of the difference between Slope A and 1 (|Slope A−1|), the calculation unit 2 calculates the degree of similarity based on Slope A. Using the absolute value of the difference between Slope B and 1 (|Slope B−1|), the calculation unit 2 calculates the degree of similarity based on Slope B. That is, the degree of similarity calculated by the calculation unit 2 is higher as the slope of the regression line is closer to 1.

For example, using the absolute value of Intercept A (|Intercept A|), the calculation unit 2 calculates a degree of similarity based on Intercept A. Using the absolute value of Intercept B (|Intercept B|), the calculation unit 2 calculates a degree of similarity based on Intercept B. That is, the degree of similarity calculated by the calculation unit 2 is higher as the intercept of the regression line is closer to 0.

For example, using the absolute value of the difference between Correlation Coefficient A and 1 (|Correlation Coefficient A−1|), the calculation unit 2 calculates the degree of similarity based on Correlation Coefficient A. Using the absolute value of the difference between Correlation Coefficient B and 1 (|Correlation Coefficient B−1|), the calculation unit 2 calculates the degree of similarity based on Correlation Coefficient B. That is, the degree of similarity calculated by the calculation unit 2 is higher as the correlation coefficient is closer to 1.

The above degrees of similarity can be used to enable quantitative comparison between results of arithmetic processing performed using each of the methods and corresponding results (results indicating true values) of arithmetic processing performed using, for example, a CPU or a GPU based on definitions of the desired processing.

The selection unit 3 compares the methods in terms of the degrees of similarity calculated by the calculation unit 2 with each other and selects Method A or Method B.

In the comparison between the methods, one of the three items obtained by the linear regression, which are the slope, the intercept, and the correlation coefficient, may be used, or two or three thereof may be used. Using only one thereof in the comparison is advantageous in that the comparison can be made in a simplified manner.

Particularly when the slope is used in the comparison, a method for which the regression line obtained as a result of the linear regression is closer to a straight line having a slope of 1, that is, a method by which the difference between two values is calculated more accurately, is selected. Using the slope in the comparison brings a particularly large effect when being applied to an event in which the difference between two value is more important.

Particularly when the intercept is used in the comparison, a method for which the regression line obtained as a result of the linear regression is closer to a straight line passing through the origin, that is, a method by which the ratio between two values is calculated more accurately, is selected. Using the intercept in the comparison brings a particularly large effect when being applied to an event in which the ratio between two values is more important.

Furthermore, particularly when the correlation coefficient is used in the comparison, a method for which the result of the linear regression is closer to a straight line, that is, a method that has a higher degree of similarity with true values in a sense that the method results in lower non-linearity (higher linearity), is selected. Using the correlation coefficient in the comparison brings a particularly large effect when being applied to an event in which low non-linearity is more important.

In contrast, using two or three of the items in the comparison is advantageous in that the accuracy of the comparison is higher because the comparison can be made in a more multifaceted manner. In particular, using the three items in the comparison is advantageous in that comparison is made in the most multifaceted manner.

When the three items are used, for example, it is also possible to find the sum of the absolute values using the three items for each of the methods by calculation such as “|the slope−1|+|the intercept|+|the correlation coefficient−1|” and compare the methods based on the sizes of these respective sums.

For example, it is also possible to find the sum of the squares using the three items for each of the methods by calculation such as “(the slope−1)²+(the intercept)²+(the correlation coefficient−1)²” and compare the methods based on the sizes of these respective sums.

Furthermore, when the absolute values are used in the comparison, for example, it is also possible to find the sum of the absolute values multiplied by respective weights, for each of the methods, by calculation such as “|the slope−1|×2+|the intercept|×3+|the correlation coefficient−1|×4” and compare the methods based on the sizes of these respective sums. While the weights are set to 2, 3, and 4 in this case, this is merely an example. The weights may be set to other values.

Furthermore, when the squares using the three items are used in the comparison, for example, it is also possible to find the sum of the squares multiplied by respective weights, for each of the methods, by calculation such as “(the slope−1)²×2+(the intercept)²×3+(the correlation coefficient−1)²×4” and compare the methods based on the sizes of these respective sums. While the weights are set to 2, 3, and 4 in this case, this is merely an example. The weights may be set to other values.

Furthermore, for example, when selecting a method from the methods, the selection unit 3 may compare the degrees of similarity, for example, in a stepwise manner as follows: (1) select a method that gives the smallest value for |the slope−1|; (2) if two or more methods have been selected in (1), select a method among these two or more methods that gives the smallest value for |the intercept|; and (3) if two or more methods have been selected in (2), select a method among these two or more methods that gives the smallest value for |the correlation coefficient−1|.

While a case in which the selection unit 3 first compares the methods in terms of |the slope−1|, then in terms of |the intercept|, and then in terms of |the correlation coefficient−1| is provided as an example above, this sequence is merely an example. As another example, the selection unit 3 may first compare the methods in terms of |the slope−1|, then in terms of |the correlation coefficient−1|, and then in terms of |intercept|, for example. The selection unit 3 may first compare the methods in terms of |the intercept|, then in terms of |the slope−1|, and then in terms of |the correlation coefficient−1|, for example. The selection unit 3 may first compare the methods in terms of |the intercept|, then in terms of |the correlation coefficient−1|, and then in terms of |the slope−1|, for example. The selection unit 3 may first compare the methods in terms of |the correlation coefficient−1|, then in terms of |the slope−1|, and then in terms of |the intercept|, for example. The selection unit 3 may first compare the methods in terms of |the correlation coefficient−1|, then in terms of |the intercept|, and then in terms of |the slope−1|, for example.

While a case in which the three items obtained as a result of linear regression that are the slope, the intercept, and the correlation coefficient are used in the comparison is described above, the same applies to a case in which any two of these items are used in the comparison.

Furthermore, the above described method is a specific example of a method for the comparison. Another comparison method that uses any degrees of similarity that are based on a result (at least one of, for example the slope, the intercept, and the correlation coefficient that correspond to each compared method) of linear regression produces an effect of enabling quantitative comparison between a plurality of methods and consequently enabling arithmetic processing that delivers higher performance.

Example of Arithmetic Processing Method

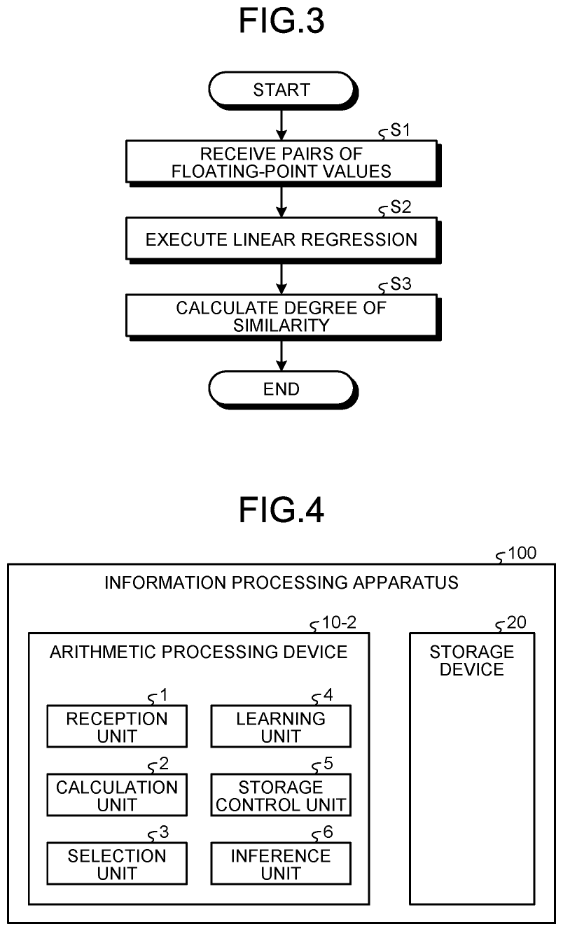

FIG. 3 is a flowchart illustrating an example of an arithmetic processing method according to the first embodiment. At the start, the reception unit 1 receives a plurality of pairs each consisting of a first floating-point value output as an output result of first processing and a second floating-point value output as an output result of second processing (step S1).

Subsequently, the calculation unit 2 performs linear regression on the pairs received in the processing at step S1 (step S2). Subsequently, based on information (for example, at least one of the slope, the intercept, and the correlation coefficient) obtained by the linear regression performed in the processing at step S2, the calculation unit 2 calculates the degree of similarity between the output results of the first processing and the output results of the second processing (step S3).

When the first processing is performed by a plurality of methods, the procedure from steps S1 to S3 is executed on output results obtained by each of the methods. When the first processing is performed by a plurality of methods, the selection unit 3 selects, based on the degrees of similarity that have been calculated at step S3, a method from the methods by which the first processing has been performed.

Comparison between results obtained by arithmetic processing performed as the first processing on an FPGA so as to correspond to, for example, a specific neural network or artificial intelligence and results obtained by arithmetic processing performed as the second processing based on definitions of the neural network or the artificial intelligence, for example, using a CPU or a GPU is not limited to comparison between the final results corresponding to and of the neural network or the artificial intelligence. The same effect as in comparison between the final results of arithmetic processing corresponding to and of the neural network or the artificial intelligence can be obtained in comparison between intermediate results obtained by performing parts thereof.

It is not limited to comparison between results obtained by performing arithmetic processing on an FPGA so as to correspond to a specific neural network or artificial intelligence and results obtained by arithmetic processing performed based on definitions of the neural network or the artificial intelligence, for example, using a CPU or a GPU, but the same effect is provided for other pairs of values.

Furthermore, as a method for quantitatively comparing a plurality of pairs of values expressed as floating-point values, linear regression is a method widely used for finding a specific form of a linear function relation between the plurality of pairs of values, as compared with, for example, a method using the absolute values of the differences between values and corresponding values in the pair. Therefore, linear regression is more advantageous than such a method in that the usefulness and the effectiveness thereof are well proven. In addition, linear regression does not involve complex arithmetic processing and is therefore advantageous in that there is no need of an apparatus capable of performing special processing. Linear regression in particular is more advantageous than general non-linear regression and multiple regression in that no complex processing is needed.

While linear regression has been conventionally used for the purpose of finding a specific form of a linear function relation between a plurality of pairs of values, that is, finding the specific values of the slope and the intercept of the linear function relation, linear regression is used for the purpose of quantifying the degree of similarity between a plurality of pairs of values in the present embodiment. That is, in the present embodiment, linear regression is used for the purpose of finding the difference between the slope and 1, the difference between the intercept and 0, and the difference between the correlation coefficient and 1, and the purpose of use of linear regression is therefore essentially different from those in conventional methods.

As described above, in the arithmetic processing device 10 according to the first embodiment, the reception unit 1 receives a plurality of pairs each consisting of a first floating-point value output as an output result of first processing and a second floating-point value output as an output result of second processing. The calculation unit 2 then performs linear regression on the plurality of pairs and, based on information obtained by the linear regression, calculates the degree of similarity between the output results of the first processing and the output results of the second processing.

Thus, the arithmetic processing device 10 according to the first embodiment enables quantitative determination of the degree of similarity between values expressed as floating-point values. As a result, for example, a method among a plurality of methods that gives values that are the closest to true values can be quantitatively determined, and highly effective arithmetic processing can be consequently performed. An effect of enabling both high-speed operation of a neural network or artificial intelligence by enabling parallel processing with processing performed, for example, using an FPGA and selection of a method that gives more accurate arithmetic results can be brought about can be provided.

### Second Embodiment

Next, a second embodiment is described. In description of the second embodiment, the same parts as those of the first embodiment are omitted, and parts different from those of the first embodiment are described. The second embodiment is described by way of an example in which, while the first processing includes at least a part of inference processing of a neural network or artificial intelligence, the second processing includes processing to read out training data for a neural network or artificial intelligence.

Example of Functional Configuration

FIG. 4 is a diagram illustrating an example of the functional configuration of an information processing apparatus 100 according to the second embodiment. The information processing apparatus 100 according to the second embodiment includes an arithmetic processing device 10-2 and a storage device 20. The arithmetic processing device 10-2 includes a reception unit 1, a calculation unit 2, a selection unit 3, a learning unit 4, a storage control unit 5, and an inference unit 6. The arithmetic processing device 10-2 according to the second embodiment includes the configuration of the arithmetic processing device 10 according to the first embodiment and further includes the learning unit 4, the storage control unit 5, and the inference unit 6.

The learning unit 4 performs learning on a parameter to be used for inference processing of a neural network or artificial intelligence. The learning unit 4 performs, a plurality of times, learning on a parameter to be used for the inference processing and, when performing the learning the plurality of times, performs the learning at least one time after the inference processing.

The storage control unit 5 stores a parameter obtained by the learning in the storage device 20. The parameter is, for example, a parameter that indicates any one of weights, biases, or the like for convolution processing. Furthermore, for example, the storage control unit 5 stores, in the storage device 20, input values to be input to the neural network or the artificial intelligence.

The inference unit 6 performs, using the parameter stored in the storage device 20, inference processing of a neural network or artificial intelligence.

In the information processing apparatus 100 according to the second embodiment, linear regression processing is performed for, for example, quantitative evaluation of the degree of similarity between results of inference processing using a provisional parameter and training values. Specifically, the reception unit 1 receives a plurality of pairs each consisting of a first floating-point value output as an output result of the inference processing using a provisional parameter and a second floating-point value that indicates training data. The calculation unit 2 performs linear regression on the plurality pairs and, based on information obtained by the linear regression, calculates the degree of similarity between the output results of the inference processing using a provisional parameter and the training data.

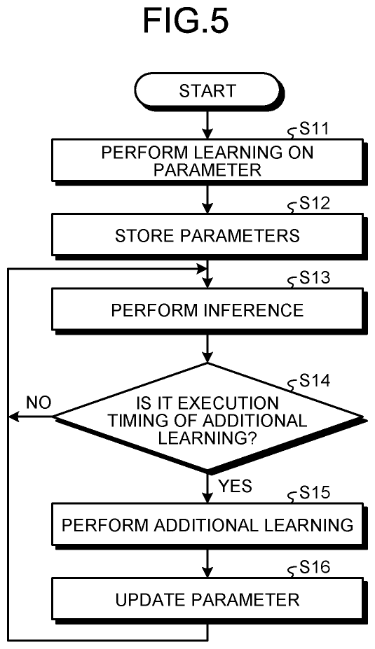

Example of Arithmetic Processing Method FIG. 5 is a flowchart illustrating an example of an arithmetic processing method according to the second embodiment. At the start, the learning unit 4 performs learning on a parameter (step S11). The parameter is, for example, a parameter such as a weight or a bias for convolution processing that is executed in processing of a neural network or artificial intelligence.

Subsequently, the storage control unit 5 stores, in the storage device, a parameter obtained by the processing at step S11 (step S12).

Subsequently, using the parameter stored in the storage device by the processing at step S12, the inference unit 6 performs inference in accordance with input values (step S13). In this inference processing, the input values input to the inference unit 6 and inference results according to the input values are stored in the storage device 20.

Subsequently, the learning unit 4 determines whether it is execution timing of additional learning (step S14). The execution timing of additional learning is, for example, when the inference processing has been performed a specific number of times. Otherwise, the execution timing of additional learning is, for example, when a specific period of time has passed since the last execution of learning.

If it is not the execution timing of execute additional learning (No at step S14), the processing returns to step S13, and the inference unit 6 continues the inference processing.

If it is the execution timing of additional learning (Yes at step S14), the learning unit 4 performs the additional learning for a neural network or artificial intelligence using the input values and the inference results stored in the storage device 20 after the inference processing is performed at step S13 (step S15). Specifically, the learning unit 4 inputs, to the reception unit 1, pairs each consisting of a first floating-point value output as an inference result of the inference processing using a provisional parameter and a second floating-point value that indicates training data. When the pairs of floating-point values are input to the reception unit 1, processing according to the above-described procedure in FIG. 3 is executed, whereby the degree of similarity with the training data (true values) is calculated. The degree of similarity is calculated for inference results each time after a different provisional parameter is used for the inference processing. The selection unit 3 selects, from a plurality of provisional parameters, one as a parameter for the inference processing to be executed after the additional learning. The one is, for example, the provisional parameter that has resulted in output of inference results that are the most similar to the training data.

Subsequently, the learning unit 4 updates the parameter based on the result of the additional learning performed by the processing at step S15 (step S16). After the processing at step S16, the processing returns to the inference processing at step S13.

Thus, the arithmetic processing device 10-2 that improves by autonomously performing inference and learning in processing of a specific neural network or artificial intelligence.

As described above, in the arithmetic processing device 10-2 according to the second embodiment, the degree of similarity based on information obtained by linear regression on pairs each consisting of a first floating-point values output by inference processing using a provisional parameter and a second floating-point value that indicates training data is calculated between the first floating-point values and the second floating-point values. The degree of similarity is calculated for inference results each time after inference processing using a different provisional parameter is performed. This enables quantitative comparison of inference results of inference processing using one provisional parameter with those using another provisional parameter. This method enables, for example, control such that, when a plurality of local optimal solutions are reached in the course of learning, a more suitable solution is selected therefrom. Therefore, the arithmetic processing device 10-2 that delivers higher performance can be provided.

### Third Embodiment

Next, a third embodiment is described. In description of the third embodiment, the same parts as those of the second embodiment are omitted, and parts different from those of the second embodiment are described. In the third embodiment, a case in which the functions of the information processing apparatus 100 according to the second embodiment are implemented by a plurality of information processing apparatuses 100.

Example of Functional Configuration

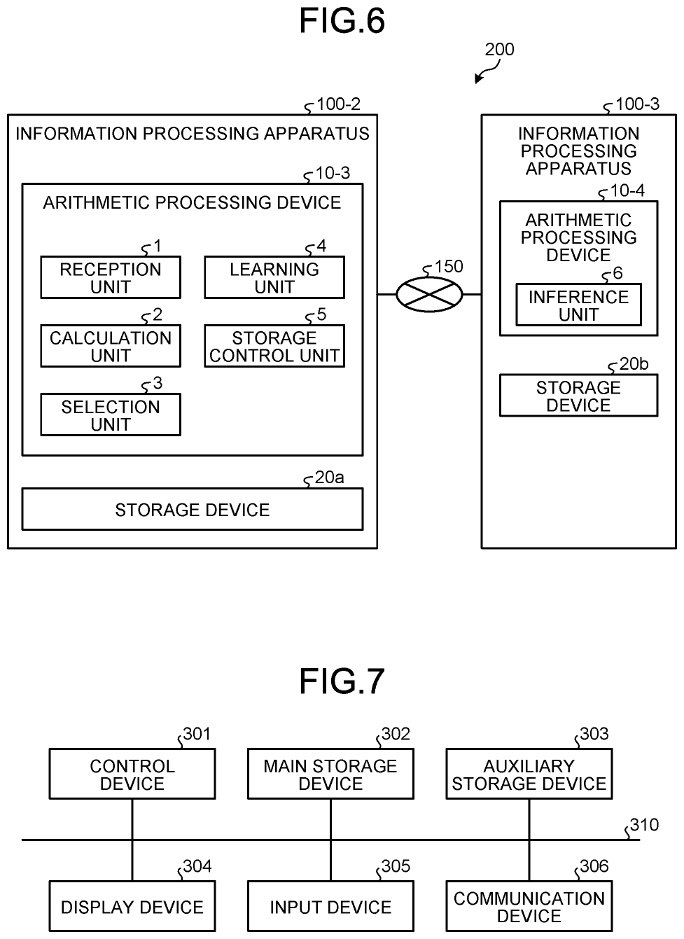

FIG. 6 is a diagram illustrating an example of the functional configuration of an information processing system 200 according to the third embodiment. The information processing system 200 according to the third embodiment includes an information processing apparatus 100-2 and an information processing apparatus 100-3. The information processing apparatus 100-2 is, for example, a cloud server apparatus. The information processing apparatus 100-3 is, for example, a terminal such as a smart device or a personal computer.

The information processing apparatus 100-2 and the information processing apparatus 100-3 are connected to each other via a network 150. A communication method that the network 150 uses may be wired or wireless. The network 150 may be implemented by a combination of wired and wireless communication methods.

Two or more of the information processing apparatuses 100-3 may be connected to the single information processing apparatus 100-2 via the network 150.

The information processing apparatus 100-2 includes an arithmetic processing device 10-3 and a storage device 20a. The arithmetic processing device 10-3 includes the reception unit 1, the calculation unit 2, the selection unit 3, the learning unit 4, and the storage control unit 5. Descriptions of the reception unit 1, the calculation unit 2, and the selection unit 3 are the same as in the second embodiment and therefore omitted.

The learning unit 4 receives, via the network 150, input values for and inference results of inference processing executed by the information processing apparatus 100-3. Using the input values for and the inference results of the inference processing and training data stored in the storage device 20a, the learning unit 4 performs learning of a parameter to be used in inference processing by a neural network or artificial intelligence.

The storage control unit 5 reads the training data stored in the storage device 20a. The storage control unit 5 stores, in a storage device 20b in the information processing apparatus 100-3, the parameter of which the learning unit 4 has performed learning.

The information processing apparatus 100-3 includes an arithmetic processing device 10-4 and the storage device 20b. The arithmetic processing device 10-4 includes the inference unit 6. The inference unit 6 performs, using the parameter stored in the storage device 20b, inference processing of a neural network or artificial intelligence.

Details of learning processing by the learning unit 4 in the information processing apparatus 100-2 and inference processing by the inference unit 6 in the information processing apparatus 100-3 are the same as those illustrated in the flowchart of FIG. 5 according to the second embodiment, and descriptions thereof are therefore omitted.

In the information processing system 200 according to the third embodiment, unlike in the configuration according to the second embodiment, the arithmetic processing device 10-3 that performs the learning processing and the arithmetic processing device 10-4 that performs the inference processing are different arithmetic processing devices. Therefore, in learning processing that needs a particularly large number of kinds of arithmetic processing, the time needed for the processing can be less by use of the arithmetic processing device 10-3 capable of performing arithmetic processing for which high-speed processing is enabled. At the same time, in inference processing, the processing can be performed with lower power consumption by use of the arithmetic processing device 10-4 that performs inference processing while being housed in, for example, a terminal.

If the learning unit 4 and the inference unit 6 are implemented in the same arithmetic processing device 10-2 as in the case of the information processing apparatus 100 according to the second embodiment, it is possible to cause the arithmetic processing device 10-2 to perform all of processing unlike in the information processing system 200 according to the present embodiment. This manner of implementation has another advantage that there is no need of communication or transfer of values to and from another processing device.

Lastly, an example of the hardware configuration of the information processing apparatus 100 (100-2 or 100-3) according to each of the second and the third embodiments is described.

Example of Hardware Configuration

FIG. 7 is a diagram illustrating an example of the hardware configuration of the information processing apparatus 100 (100-2 or 100-3) according to each of the second and the third embodiments.

The information processing apparatus 100 includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected to one another via a bus 310.

The control device 301 executes a computer program that has been read into the main storage device 302 from the auxiliary storage device 303. The control device 301 corresponds to the arithmetic processing device 10 (10-2, 10-3, or 10-4) described above.

The main storage device 302 is a memory such as a read-only memory (ROM) or a random access memory (RAM). The auxiliary storage device 303 is, for example, a hard disk drive (HDD), a solid state drive (SSD), or a memory card. The main storage device 302 and the auxiliary storage device 303 correspond to the storage device 20 (20a or 20b).

The display device 304 displays thereon information to be displayed. The display device 304 is, for example, a liquid crystal display. The input device 305 is an interface to be used for operating a computer. The input device 305 is, for example, a keyboard or a mouse. When the computer is a smart device such as a smartphone or a tablet terminal, the display device 304 and the input device 305 are, for example, a touch panel. The communication device 306 is an interface to be used for communicating with other apparatuses.

The computer program to be executed on the computer is stored as a file having an installable format or an executable format in a computer-readable storage medium, such as a compact disc read-only memory (CD-ROM), a memory card, a compact disc recordable (CD-R), or a digital versatile disc (DVD) and provided as a computer program product.

The computer program to be executed on the computer may also be configured to be stored in a computer connected to a network such as the Internet and be provided by being downloaded via the network. The computer program to be executed on the computer may also be configured to be provided via a network such as the Internet without being downloaded.

The computer program to be executed on the computer may be provided by being embedded in, for example, the ROM.

The computer program to be executed on the computer is constructed in modules that include, out of the functional configuration (functional blocks) of the information processing apparatus 100 (100-2 or 100-3) described above, functional blocks that can also be implemented as a computer program. In terms of physical hardware, these functional blocks are loaded into the main storage device 302 by having the computer program read out from a storage medium and executed by the control device 301. That is, the individual functional blocks described above are generated on the main storage device 302.

At least one of the individual functional blocks described above may be implemented not as software but as hardware such as an integrated circuit (IC).

When individual functions are implemented using a plurality of processors, each of the processors may implement one of the individual functions or may be implemented two or more of the individual functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An arithmetic processing device comprising:
one or more hardware processors configured to function as:
a reception unit configured to receive a plurality of pairs each consisting of a first floating-point value output as an output result of first processing and a second floating-point value output as an output result of second processing; and
a calculation unit configured to perform linear regression on the plurality of pairs and calculate a degree of similarity between output results of the first processing and output results of the second processing, based on information obtained by the linear regression.

2. The device according to claim 1, wherein the calculation unit is configured to calculate the degree of similarity based on at least one of a slope of a regression line obtained by the linear regression, an intercept of the regression line, and a correlation coefficient obtained by the linear regression.

3. The device according to claim 2, wherein the calculation unit is configured to calculate the degree of similarity to be higher as the slope of the regression line is closer to 1.

4. The device according to claim 2, wherein the calculation unit is configured to calculate the degree of similarity to be higher as the intercept of the regression line is closer to 0.

5. The device according to claim 2, wherein the calculation unit is configured to calculate the degree of similarity to be higher as the correlation coefficient obtained by the linear regression is closer to 1.

6. The device according to claim 1, wherein
the first processing is executed using a field programmable gate array (FPGA), and
the second processing is executed using a central processing unit (CPU) or a graphics processing unit (GPU).

7. The device according to claim 1, wherein
the first processing includes at least part of inference processing of a neural network or artificial intelligence, and
the second processing includes processing of reading out training data for the neural network or the artificial intelligence.

8. The device according to claim 7, further comprising:
a storage device, wherein
the hardware processors are further configured to function as:
a learning unit configured to perform learning on a parameter to be used in the inference processing;
a storage control unit configured to store, in the storage device, a parameter obtained by the learning; and
an inference unit configured to perform the inference processing using the parameter, and wherein
the reception unit is configured to receive the plurality of pairs each consisting of the first floating-point value output as an output result of the inference processing and the second floating-point value that indicates the training data,
the calculation unit is configured to perform the linear regression on the plurality of pairs and calculate the degree of similarity between the output results of the inference processing and the training data, based on information obtained by the linear regression, and
the learning unit is configured to update the parameter based on the degree of similarity.

9. The device according to claim 8, wherein the learning unit is configured to perform, a plurality of times, learning on the parameter to be used for the inference processing and perform, after the inference processing, the learning at least one time of the plurality of times.

10. An information processing apparatus comprising:
a storage device configured to store therein a parameter; and
an arithmetic processing device, wherein
the arithmetic processing device comprises:
a learning unit configured to perform learning on the parameter to be used in inference processing of a neural network or artificial intelligence;
a storage control unit configured to store, in the storage device, the parameter obtained by the learning;
an inference unit configured to perform the inference processing using the parameter;
a reception unit configured to receive a plurality of pairs each consisting of a first floating-point value output as an output result of the inference processing and a second floating-point value that indicates training data for the neural network or the artificial intelligence; and
a calculation unit configured to perform linear regression on the plurality of pairs and calculate a degree of similarity between output results of the inference processing and the training data, based on information obtained by the linear regression, and
the learning unit is configured to update the parameter based on the degree of similarity.

11. An arithmetic processing method comprising:
receiving, by an arithmetic processing device, a plurality of pairs each consisting of a first floating-point value output as an output result of first processing and a second floating-point value output as an output result of second processing;
performing, by the arithmetic processing device, linear regression on the plurality of pairs; and
calculating, by the arithmetic processing device, a degree of similarity between output results of the first processing and output results of the second processing, based on information obtained by the linear regression.
